(19) United States
(12) Patent Application Publication
(10) Pub. No.: US 2021/0291669 A1
(43) Pub. Date: Sep. 23, 2021

(54) YW Extended Range Battery

(71) Applicant: Munir Ibrahim Vohra, Sugar Land, TX (US)

(72) Inventor: Munir Ibrahim Vohra, Sugar Land, TX (US)

(21) Appl. No.: 17/144,064

(22) Filed: May 27, 2021

(51) Int. Cl. B60L 50/62; B60L 53/16; H02J 7/14

(52) U.S. Cl. CPC B60L 50/62; H02J 7/14; B60L 53/16

(57) ABSTRACT

A method for allowing electric car batteries to produce minimal amounts of charge as it is driven so that the vehicle can deliver longer ranges in between charges comprises of the following steps: generating kinetic energy at approximately 7 mph from wheels in motion; the kinetic energy is then converted into electric energy by a generator; a transformer would increase the voltage and send the energy to an internal charging port using a supply wire.

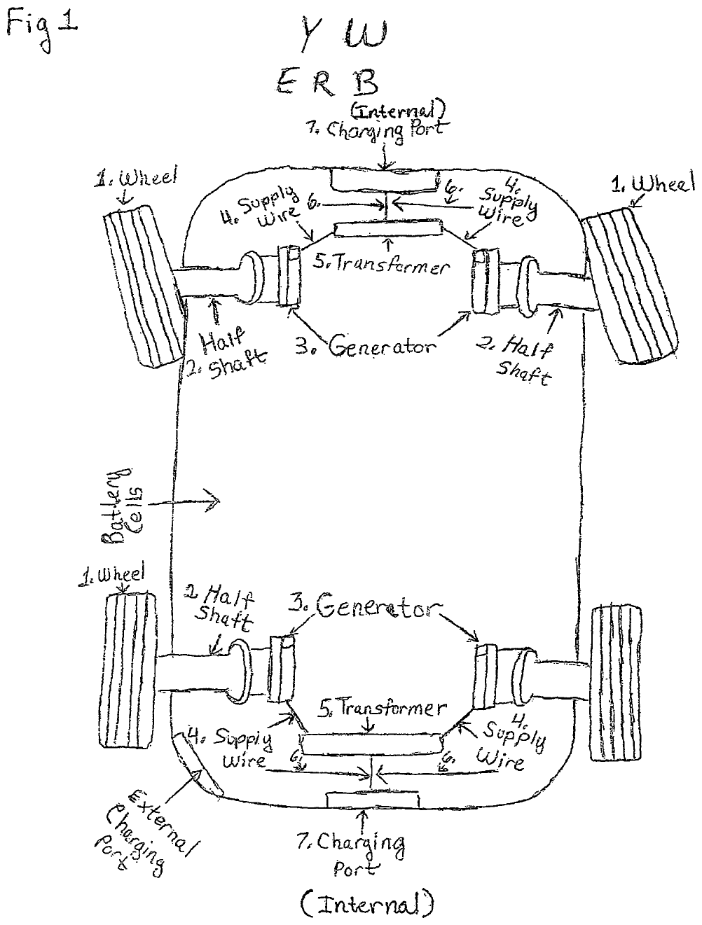

A method of the current invention allows the vehicles electric battery to run the miles indicated by the manufacturer and possibly even give it a longer range comprising of the

following steps:

1. Wheels of any size rotate in either direction and begin generating kinetic energy at approximately 7 mph.

2. The wheels connect to a shaft or half shaft forcing the shaft to turn at the same/less/more speed as the wheels.

3. The shaft or half shaft is connected to a generator.

4. The generator converts the kinetic energy to electric energy.

5. Energy converted from the generator moves through a supply wire to a transformer.

6. The transformer increases the voltage of the electricity generated.

7. The increased voltage flows through another supply wire.

8. The voltage from the supply wire flows to the internal charging port to recharge the battery cells.

I claim:

1-7. (canceled)

8. A method for allowing electric car batteries to produce minimal amounts of charge as the car is driven so that the vehicle can deliver longer ranges in between charges comprises of the following steps: generating kinetic energy at approximately & mph from wheels in motion; the kinetic energy is then converted into electric energy by a generator, a transformer would increase the voltage and send the energy to an internal charging port using a supply wire.
